(19) United States
(12) Patent Application Publication
(10) Pub. No.: US 2017/0093517 A1
(43) Pub. Date: Mar. 30, 2017

(54) A PARALLEL OPTOELECTRONIC NETWORK THAT SUPPORTS A NO-PACKET-LOSS SIGNALING SYSTEM AND LOOSELY COUPLED APPLICATION-WEIGHTED ROUTING

(71) Applicant: VISCORE TECHNOLOGIES INC., KANATA (CA)

(72) Inventors: YUNQU LIU, KANATA (CA); KIN-WAI LEONG, OTTAWA (CA); WENDA NI, OTTAWA (CA); CHANGCHENG HUANG, OTTAWA (CA)

(21) Appl. No.: 15/311,136

(22) PCT Filed: May 13, 2015
(86) PCT No.: PCT/CA2015/000313

§ 371 Date: Nov. 14, 2016

Related U.S. Application Data
(60) Provisional application No. 61/992,570, filed on May 13, 2014.

(51) Int. Cl. H04J 14/02; H04B 10/27

(52) U.S. Cl. CPC H04J 14/0278; H04B 10/27; H04J 14/0238

(57) ABSTRACT

A hybrid optical electronic mapper-shuffler-reducer structure is presented to enhance the interconnection of current multi-dimensional direct networks. The physically intrinsic multicast design of the hybrid optical electronic mapper-shuffler-reducer structure of the present disclosure naturally supports parallel traffic modes such as multicast, broadcast and newly developed incast, while easily supporting point-to-point traffic. By scaling up this architecture, using a simple multi-dimensional topology, a remarkably massive network can be achieved with only 3 hops end-to-end latency. Compared to other multi-dimensional direct networks, the latency is substantially improved and is also made more uniform.

### CROSS-REFERENCE TO RELATED APPLICATIONS

This patent application claims the benefit of Patent Cooperation Treaty Application PCT/CA2015/000,313 entitled “A Parallel OptoElectronic Network that Supports a No-Packet-Loss Signaling System and Loosely Coupled Application-Weighted Routing” filed May 13, 2015, which itself claims the benefit of U.S. Provisional Patent Application 61/992,570 filed May 13, 2014 entitled “Parallel OptoElectronic Network that Supports a No-Packet-Loss Signaling System and Loosely Coupled Application-Weighted Routing”, and U.S. Provisional Patent Application 61,992,580 filed Sep. 12, 2014 entitled “A Parallel OptoElectronic Network that Supports a No-Packet-Loss Signaling System and Loosely Coupled Application-Weighted Routing”, the entire contents of both being included by reference.

### FIELD OF THE INVENTION

The present disclosure relates to multi-dimensional direct networks, particularly to a parallel optoelectronic direct network with intrinsic parallel traffic mode support and latency reduction.

### BACKGROUND

Multi-dimensional direct networks are popular in high performance and parallel computing designs. Among them, the Hypercube and 3D torus are classic examples.

In a multi-dimensional direct network, point-to-point links between nodes is the dominant interconnect solution. Each node in the network is connected to one or more other nodes through one or more interconnect links. However, networks built on such connections (interconnections) have very high diameters when they scale up. A network diameter can be defined as the average minimum distance between pairs of nodes. As an example, a 1000-node network will have a diameter of 30 hops. A large network diameter increases the latency of the network.

In such networks, the computing jobs have to be carefully aligned to take into account their locality of reference constraints. Traditionally, a direct-network structure is used for supercomputing applications, such as atmospheric simulations. Such applications naturally have locality feature. They are not affected by the locality limitation brought about by the above-noted high network diameter and latency issues.

Today's large datacenters and massive computing projects demand a different network which is large scale (larger than 1000 nodes) and capable of supporting a parallel traffic load. In particular, most of the computing tasks within the datacenter are parallel in nature and require consistent and low latency for optimal performance.

Existing point-to-point based interconnection network designs such as InfiniBand, struggle to support parallel traffic such as multicast. InfiniBand, which is a switch-based point-to-point interconnection system, offers a pseudo multicast support based on an unreliable datagram protocol (UDP) queue pair which introduces package drop, re-sends, and unpredictable performance. The root-cause of this limitation lies in the fundamental cross bar switching function inherent in such point-to-point interconnection fabric.

Other aspects and features of the present invention will become apparent to those ordinarily skilled in the art upon review of the following description of specific embodiments of the invention in conjunction with the accompanying figures.

### SUMMARY

The present disclosure provides a hybrid optical electronic mapper-shuffler-reducer structure than endeavors to address the issues noted above and enhances the interconnection of current multi-dimensional direct networks. The physically intrinsic multicast design of the hybrid optical electronic mapper-shuffler-reducer structure of the present disclosure naturally supports parallel traffic modes such as multicast, broadcast and newly developed incast, while easily supporting point-to-point traffic. By scaling up this architecture, using a simple multi-dimensional topology, a remarkably massive network can be achieved with only 3 hops end-to-end latency. Compared to other multi-dimensional direct networks, the latency is substantially improved and is also made more uniform.

The physical mapper-shuffler-reducer design of the present disclosure obviates the need for a cross-bar switch function. Consequently, it does not have limitations associated with a cross bar switch function.

The present disclosure provides physical mapper-reducer-shuffler hybrid design that comprises an optical mapper and an electronic shuffler and reducer. According to an embodiment of the invention there is provided an optical network comprising:

at least one optical mapper of a plurality of optical mappers; and
at least one electronic shuffler and reducer circuit of a plurality of electronic shuffler and reducer circuits, each electronic shuffler and reducer circuit coupled to an output port of an optical mapper of the plurality of optical mappers.

According to an embodiment of the invention there is further provided an optical amplifier array for amplifying either the input signals to a predetermined subset of the optical mappers and the output signals of a predetermined subset of the optical mappers, wherein each optical amplifier within the optical amplifier array is coupled to at least one other optical amplifier in order to provide for optical pump reuse.

According to an embodiment of the invention there is provided a method of routing optical signals from a network input port to a network output port comprising:

providing at least one optical mapper of a plurality of optical mappers, the optical mapper coupled to at least the network input port; and
providing at least one electronic shuffler and reducer circuit of a plurality of electronic shuffler and reducer circuits, each electronic shuffler and reducer circuit coupled to an output port of an optical mapper of the plurality of optical mappers and coupled to the network output port.

According to an embodiment of the invention there is provided a device comprising:

an wavelength demultiplexer for receiving a wavelength division multiplexed optical signal and demultiplexing it to a plurality of optical outputs, each optical output associated with a predetermined wavelength range;

a multiplexer for generating a multiplexed signal by multiplexing a plurality of electrical signals;

a plurality of channel processors, each channel processor coupled to an optical output of the plurality of optical outputs and comprising;
an optoelectronic converter; and
a serial to parallel converter coupled to the optoelectronic converter and generating parallel data in dependence upon serial data received by the serial to parallel converter from the optoelectronic converter;

a shuffle circuit comprising a plurality of input channels and a plurality of output channels, each input channel coupled to a predetermined channel processor of the plurality of channel processors and each output channel coupled to the a predetermined input port on the multiplexer to provide an electrical signal of the plurality of electrical signals.

According to an embodiment of the invention there is provided a device comprising:

a fully connected optical distribution network comprising N input channels for receiving N optical signals comprising optical signals according to a predetermined optical channel plan and M output channels wherein each output channel comprises all optical signals received at the N input channels; and
M mapper—reducer circuits, each mapper—reducer circuit coupled to an output channel of the fully connected optical distribution network.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 depicts an embodiment of a mapper-reducer system according to an embodiment of the invention operationally connected to transmitters and receivers.

FIG. 2A depicts an example of a 9×9 mapper according to an embodiment of the invention.

FIG. 2B depicts an example of an 18×18 mapper according to an embodiment of the invention.

FIG. 2C depicts an example of a 36×36 mapper according to an embodiment of the invention.

FIG. 3 depicts an embodiment of a reducer-shuffler according to an embodiment of the invention.

FIG. 4 depicts an embodiment of a 64-bit pattern according to an embodiment of the invention.

FIG. 5 depicts a reducer-shuffler configured for unicast reception according to an embodiment of the invention.

FIG. 6 depicts a plurality of nodes interconnecting an optical mapper of a first dimension and an optical mapper of a second dimension according to embodiments of the invention.

FIG. 7 depicts the context of a signaling system for pushing data (traffic) back for the nodes on the same mapper according to an embodiment of the invention.

FIG. 8 depicts a signaling system according to an embodiment of the invention wherein a heartbeat message is sent from a transmitter to four reducers for them to identify if and when the transmitter fails or is no longer available.

FIG. 9 depicts an example of signaling occurring during traffic surges according to an embodiment of the invention.

FIG. 10 depicts exemplary tables used in an embodiment of application-weighted routing according to an embodiment of the invention.

FIG. 11 depicts an example of a high port count network with an efficient optical amplifier design according to an embodiment of the invention.

### DETAILED DESCRIPTION

The present invention is directed to multi-dimensional direct networks, particularly to a parallel optoelectronic direct network with intrinsic parallel traffic mode support and latency reduction.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

FIG. 1 shows an embodiment of a mapper reducer system 18 in accordance with the present disclosure. For purposes of clarity, only four transmitters 22 and four receivers 24 are shown respectively as inputs to, and outputs form, the mapper reducer system 18. An optical mapper 20 receives transmitted data from transmitters 22. Each transmitter transmits data at a wavelength distinct from that of the other transmitters. The optical mapper-reducer 18 simultaneously provides data from each of the four transmitters to each destination node at which a reducer (reducer-shuffler) 25 and a receiver 24 are located. The mapper 20 splits the optical power from each transmitter 22 into K parts, one part for each of the K destination nodes (in the present embodiment, K=4). This optical function is also referred to as an Optical Star Coupler.

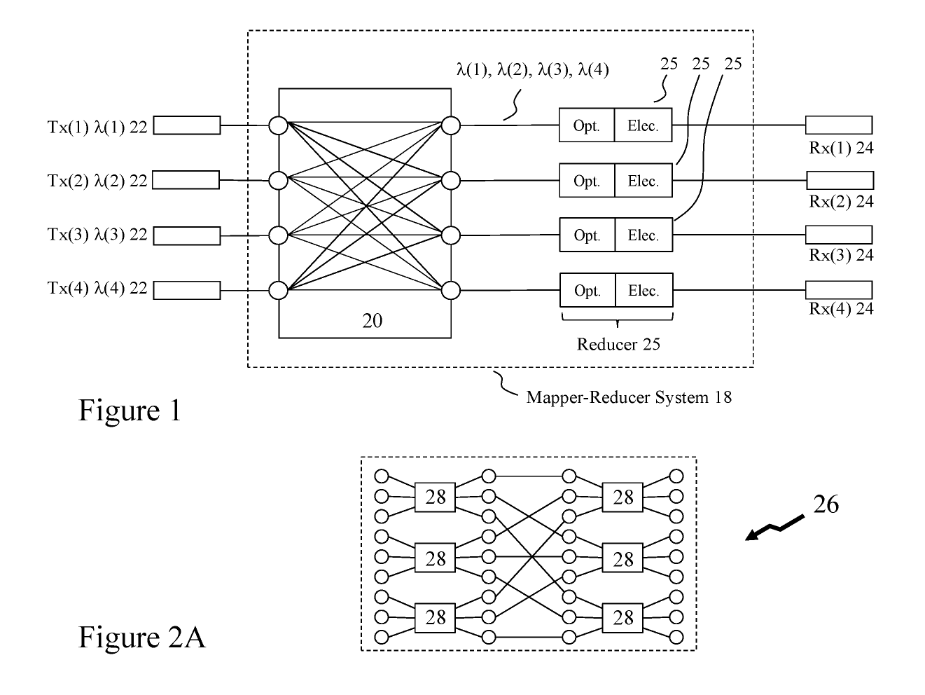

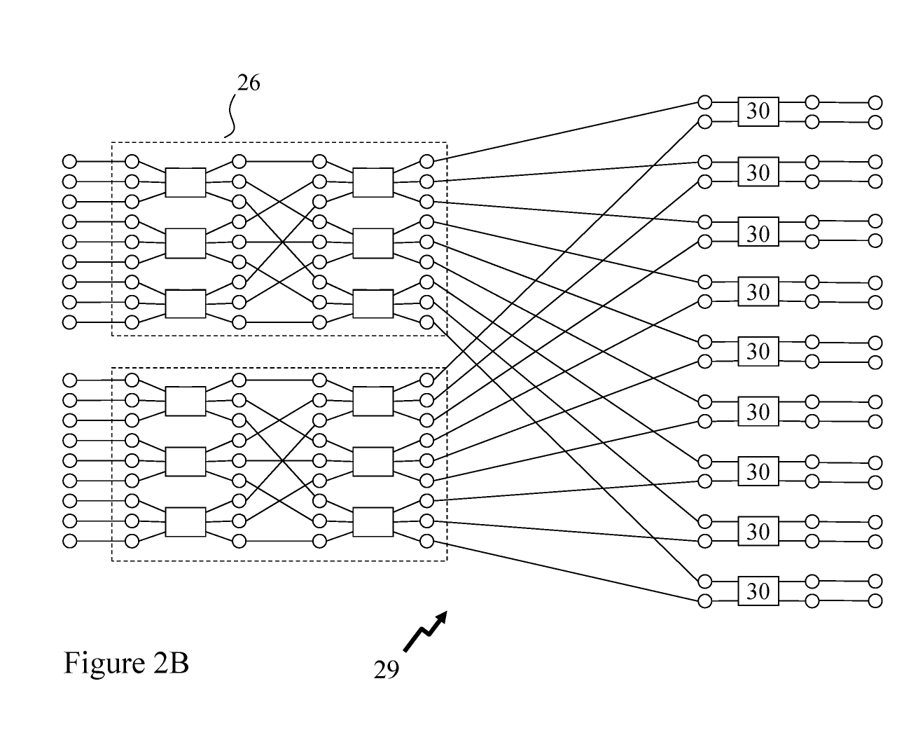

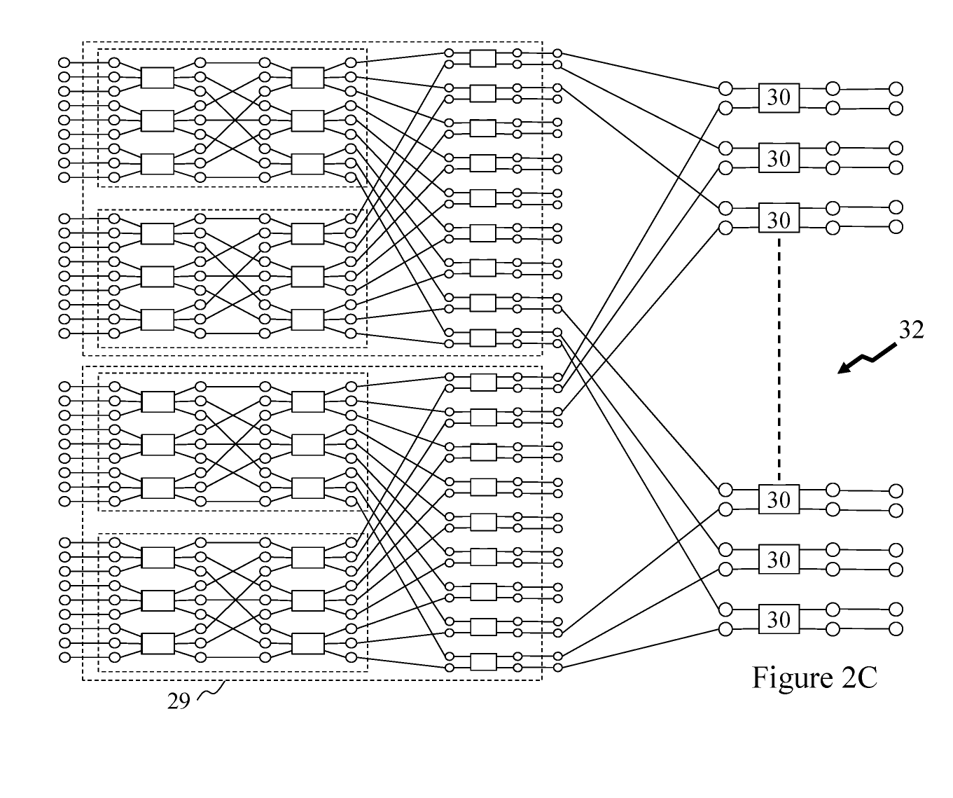

FIGS. 2A, 2B and 2C show exemplary embodiments of a mapper in accordance with the present disclosure.

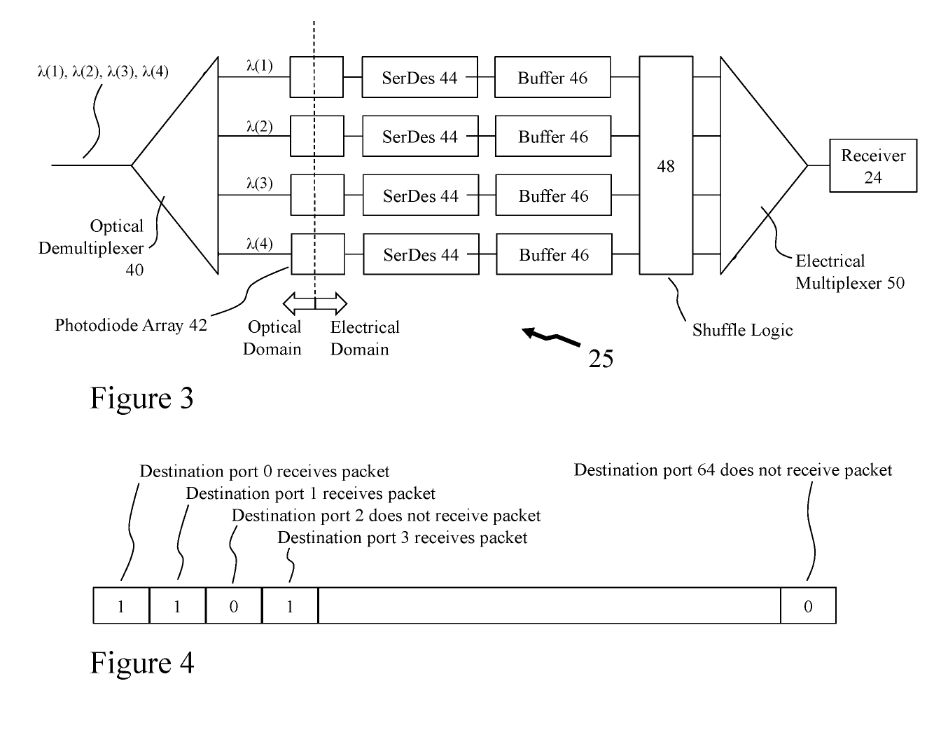

FIG. 2A shows an embodiment of a 9×9 mapper 26 constructed from six 3×3 fused fiber couplers 28. FIG. 2B shows an embodiment of an 18×18 mapper 29 constructed from two 9×9 mappers 26 and 2×2 fused fiber couplers 30. FIG. 3C shows an embodiment of a 36×36 mapper 32 constructed from two 18×18 mappers 29 and 2×2 couplers 30.

A distributed shuffle method is introduced, and physically co-located within each reducer 25 (FIG. 1), within the electrical circuitry of the reducer 25.

FIG. 3 shows an embodiment of a reducer 25 in accordance with the present disclosure. The reducer 25 comprises an optical demultiplexer 40 that receives multiple data streams at multiple wavelengths (four in the present example) and demultiplexes these multiple wavelengths into individual wavelength channels. The demultiplexed wavelengths are provided to a photodiode array 42 where their optical data signals are detected and transformed into electrical data signals. Each electrical data signal is provided to a SerDes 44, which transforms the serial electrical data into a parallel data signal and provides the parallel data signal to a buffer 46. The output of each buffer 46 is input into a shuffle logic 48 that combines bits from the four parallel channels to generate the bits stream to output to the receiver 24. The shuffle logic could be as simple as a single logic function, e.g. XOR, OR, AND, or NOR, or as complicated as a CDMA matrix operation. The shuffle logic can comprise and suitable number of logic elements such as, for example, XOR, OR, AND and NOR elements programmed into FPGA. ASIC circuitry can also be used. The shuffle logic generally combines a matrix of arrays of bit streams into a serial bit stream which could be the same, shorter or longer than the width of the matrix. (e.g., four bit streams 1100, 0011, 0000, 0000, and reduce them into one stream 1010). The output of the shuffle logic 46 is input to an electrical multiplexer 50. The output of the electrical multiplexer is input into a receiver 24.

The shuffle logic 48 can cause any suitable combination of the electrical data signals output from the buffers 46 to be provided to the receiver 24.

The present disclosure can enable multicasting by using bit marking to indicate the destination nodes that should receive a data packet. Only one bit is used to define if a packet is for a specific receiving port. Since we use only one bit to mark the multicast, the penalty is minimized. As an example, in a 64 ports Mapper-Reducer system, the penalty is 64 bits which is about 6.4 ns delay in a 10 Gb/s network. FIG. 4 shows a 64 bit sequence where each bit identifies if the destination port corresponding to the bit in question should receive the data packet.

Returning to FIG. 1, the mapper-reducer system 25 intrinsically supports switching, multicasting, broadcasting and incasting.

First, let us focus on one-to-one traffic scenario which is equivalent to a “switch”. Consider data marked for destination Rx₃ starting from Tx₁ in FIG. 1. The data starts from Tx₁ (Laser, 1 mw power, lambda 1), goes into a single fiber. The data then goes into the Mapper 20 at light speed in the single fiber and is divided into four identical copies by the Mapper 20. The power on every copy is ¼ mW. Each of the four copies of the data goes to each of the four reducers 25. Subsequently, the reducer 25 coupled to the receiver Rx₃ provides the data to Rx₃. The other reducers drop their copy of the data.

At the end of this process, the data is “switched” from Tx₁ to Rx₃. The geographically separated (meter to kilometers) mapper-reducer together make up the “switch”, but there is not a single physical switch in the mapper-reducer system 18. The key point is that, in the present disclosure, the data is not processed or routed or switched, until the very end. This is different from switching schemes that use tunable laser, tunable filter, and other switch fabric and that switch data before it reaches the receiver.

Unlike in a shared bus medium, a different wavelength is used in each transmitter. That allows the different wavelengths to carry independent streams of data at line rate. In the mapper 20, we split the optical power to make copies of the data. In the reducers 25, data from different transmitters (wavelengths) is de-multiplexed and fed to an array of photo detectors, and then processed electronically.

In the mapper-reducer system, multiple identical copies of data are carried. It provides the destination with all of the data needed for the reducers (reducer-shufflers) to decide which receiver receives which data. The tradeoff in doing so is that we have to divide out optical power, deploy optical DMUXs and photodetectors. Nevertheless, the optical power (1 mw), D-MUX, and photo detector arrays are available and cost effective.

If the traffic mode is only one-to-one (switch) then the physical mapper-shuffler-reducer scheme could be regarded as overkill. However, its intrinsic power becomes clearer when one considers parallel traffic which is increasingly important for datacenter, especially parallel applications.

Broadcast (one-to-all)—in the example above, it would be just as easy to have all four of Rx₁, Rx₂, Rx₃, Rx₄ receive the data from Tx₁ simultaneously.

Multicast (many-to-many)—e.g. suppose Tx₁ would like to send data to Rx1, Rx2, and Rx3, while at the same time, Tx2 would like to send different data to Rx2, Rx3, and Rx4. Tx2 would send its data on a different wavelength lambda 2 in the same manner as described above. This is intrinsically possible with the mapper-reducer architecture of the present disclosure. However, all other existing switched-based architectures are struggling to support multicasting.

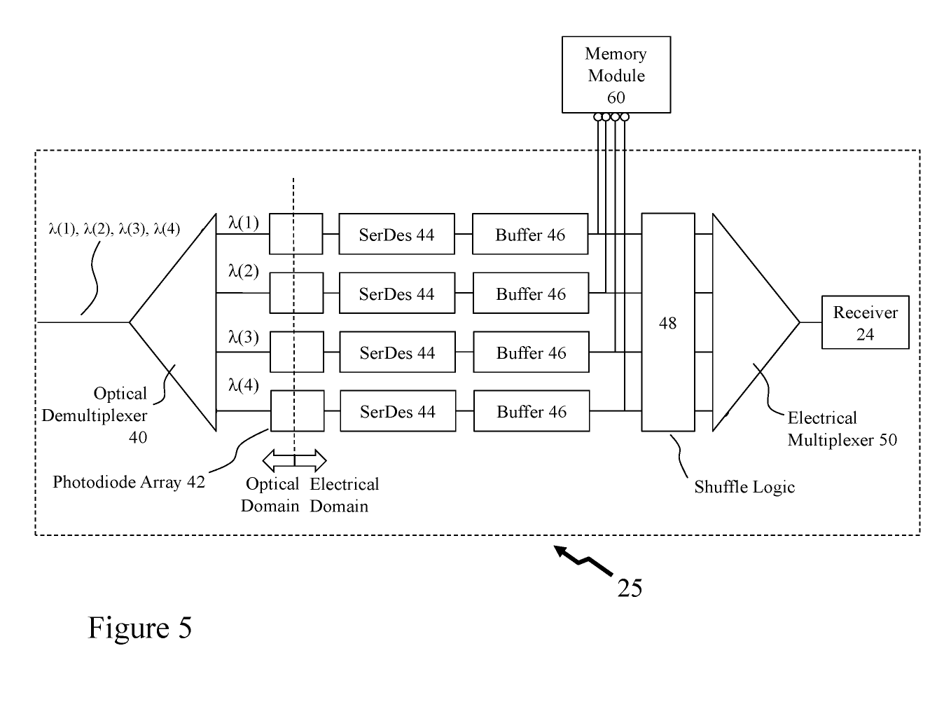

Incast (many-to-one)—suppose Tx1, Tx2, Tx3, Tx4 would all like to each send a data to Rx1 at the same time; this can be supported by our mapper-shuffler-reducer. This traffic mode is impossible for all other existing switched-based architectures. FIG. 5 shows an embodiment of the present disclosure where the circuitry of a reducer can be modified to support incast traffic. In the example of FIG. 5, the shuffle logic 48 and the electrical multiplexer 50 are not used when the reducer 25 is in incast traffic mode. Rather, the data from the electrical data signals output from the buffers 46 is stored in a memory module 60. The memory module can be configured to write the data from each channel (four channels in the present example) to shared memory in a round-robin fashion using a Direct Memory Access method. For instance, 64 channels of 10 Gb/s data signals could require the memory module to have a capacity of 640 Gbits per second.

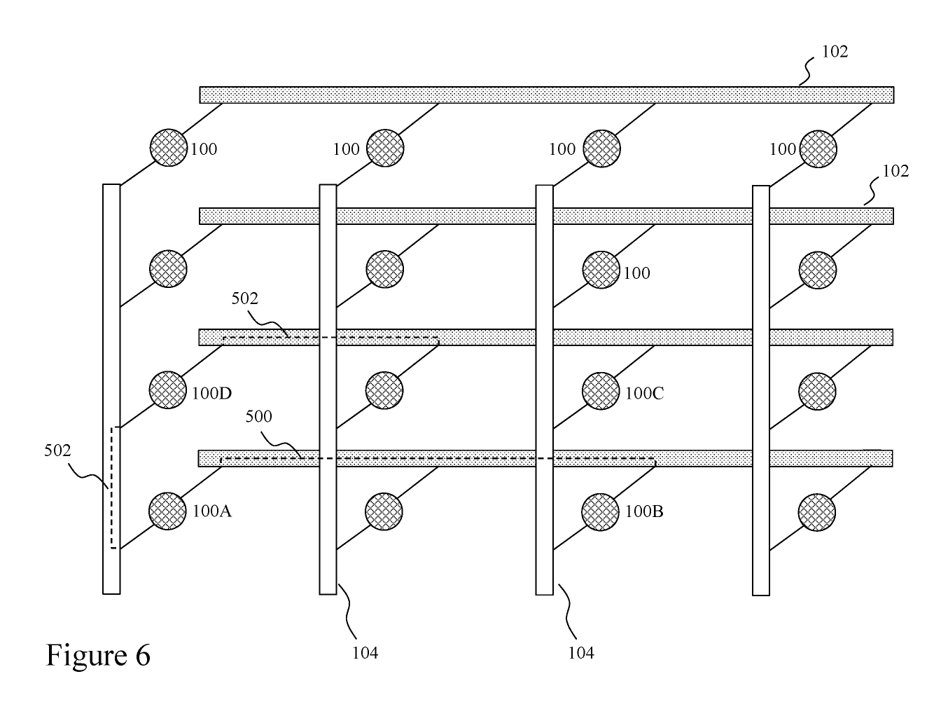

A simple Cartesian direct-product is used to extend the mapper-shuffler-reducer architecture to higher dimensions and scale to larger networks. At each node, data can “hop” from one dimension to another through an electronic-to-optical conversion. The key is that the different dimensions are optically isolated from each other; therefore, wavelengths can be re-used in different dimensions. The result is a remarkable ability to scale networks. As an example, for an 80-port mapper-shuffler-reducer design based on existing DWDM technology, the 3D layout scale is 512K nodes, and the 2D layout has 80×80=6400 nodes. For a low-cost 18-port mapper-shuffler-reducer design of the present disclosure, based on low cost CWDM technology, the 3D layout scale is 18×18×18=5832 nodes. In principle, the optical fiber wavelength window can support up to 400 different wavelength channels, so that a 3D layout scale can theoretically scale to 400×400×400=64 million nodes, with only three hops. A simpler example is provides at FIG. 6, which shows nodes 100. Each node interconnects a mapper 102 of a first direction to a mapper 104 of another direction. In the present disclosure, the first and second directions relate to orthogonal directions in the Cartesian plane in which the nodes 100 are shown. The first direction is parallel to the mappers 102; the second direction is parallel to the mappers 104. A third direction is possible but not shown. The third direction would be extending perpendicularly to the plane of the page on which FIG. 6 is shown.

To go from node 100a to node 100b, only one hop is required, as shown by the path 500. To go from node 100a to node 100c, only two hops are required, as shown by path 502. A first hop is from node 100a to node 100d and the second hope is from node 100d to node 100c. In the example of FIG. 6, two hops is the maximum number of hops required to go from any node to any other node. When a third direction is added, the maximum number of hops required to go from any node to any other node is three.

Each node can include, for examples, elements such as storage elements, storage control elements, processors, transmitters, network control elements, etc.

To unleash the power of the mapper-reducer system or structure of the present disclosure, a signaling system is proposed to offer no-packet-loss physical layer networking. The signaling system of the present disclosure uses a broadcast status of nodes in the network to determine when to transmit packets. When a node is busy and cannot process a packet, the packet is not sent. A packet is sent only when the node can receive the packet (the risk of losing a packet is very small).This is how a network having the present signaling system can be essentially a no-packet-loss network.

FIG. 7 shows an example of how data (traffic) can be pushed back for the nodes on the same mapper.

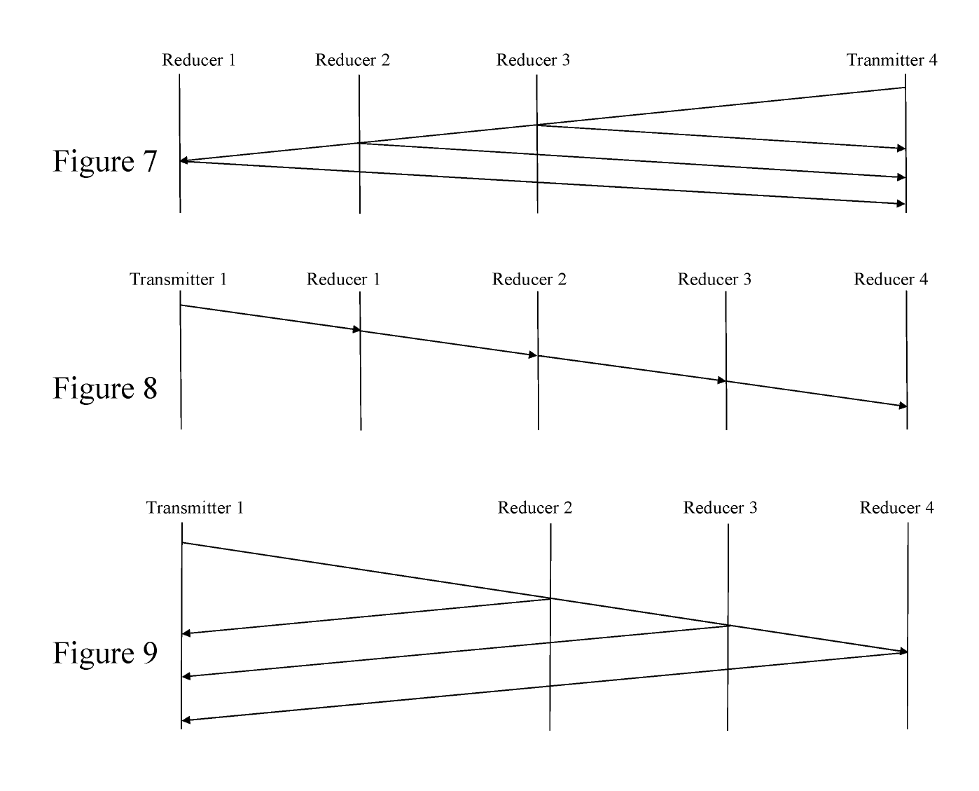

FIG. 8 shows an example of a heartbeat message sent from a transmitter to four reducers in order for the reducers to identify if and when the transmitter fails or is no longer available.

FIG. 9 shows an example of messaging occurring during traffic surges. The transmitter 1 transmits a packet and waits for a fixed time period to ensure that the packet has reached its destination. As there is nominally no packet loss, there is no need to wait for an acknowledgment (ACK) message to be sent by the node that has received the packet. However, it is still possible to implement such ACK messages.

With the strong (i.e., no packet loss) physical layer, we propose a loosely coupled application routing method. Unlike the black-box IP routing, this application-routing opens the routing policies to applications. Also, it is different from tightly coupled telecom routing (e.g. circuit switch, ATM Virtual Channel).

With the guaranteed no-package-loss feature in the physical layer, the network is capable to open routing to application layers. The present disclosure allows for loosely-coupled application-weighted routing process. Routing APIs are built and open to applications. Application can define the weight of the routes they prefer based on their understanding of application traffic mode. Also, application layer can veto certain routes by setting that precise route weighting to zero. However, the routing layer wouldn't allow application layer to veto all routes.

The routing layer can sum up weight tables of all applications and then multiply that with the routing priority table generated and managed by the routing layer. Then, the application-weighted-routing-table will be used for the routing decisions.

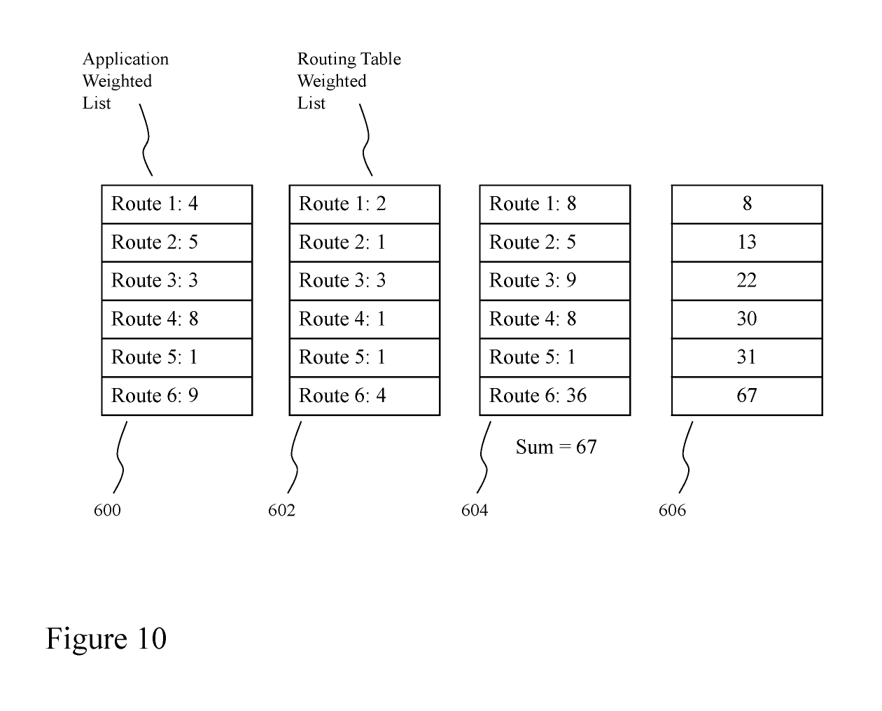

FIG. 10 shows an application weighted list 600 indicating that the weight associated to each of Routs 1-6. Route 6 is the preferred route with a weight of 9; Route 5 is the least favorite route with a weight of 1. None of the routes have been vetoed by the application. That is, none of the routes have a weight of zero (0). FIG. 10 also shows a pre-determined routing table weighted list 602 indicating that Route 6 is the preferred route with a weight of 4 and that Routes 2, 4 and 5 are the least favorite routes with a weight of 1. Further, FIG. 10 shows a table 604 whose entries correspond to the product of the weights of the application weighted list 600 and the routing table weighted list 602. The sum of the entries of table 604 is indicated as being 67.

As an example, to determine which route to assign to particular packets, a random number generator generates a random number comprised between 0 and 67. Subsequently, the randomly generated number is compared to the running sum for each entry of table 604. The running sum for route 1 is “8”, the running sum for route 2 is “8+5=13”, the running sum for route 3 is “8+5+9=22”, for route 4: “8+5+9+8=30”, for route 5: “8+5+9+8+1=31”, and for route 6: “8+5+9+8+1+36=67”. Table 606 shows the running total for each route.

When the random number is between 0 and 8, the route selected will be Route 1. When the random number is between 9 and 13, the route selected will by Route 2. When the random number is between 13 and 22, the route selected will be Route 3. When the random number is between 22 and 30, the route selected will be Route 4. When the random number is between 30 and 31, the route selected will be Route 5. When the random number is between 31 and 67, the route selected will be Route 5.

Over the course of time, Route 5 should be selected the most often, as it is the route that has the highest weight in both tables 600 and 602.

In the process of managing traffic, the routing layer maintains the privilege to adjust the traffic distribution of the routes to deliver the best networking performance to application layer. These decisions will be reported to the application layer for applications weight-optimization.

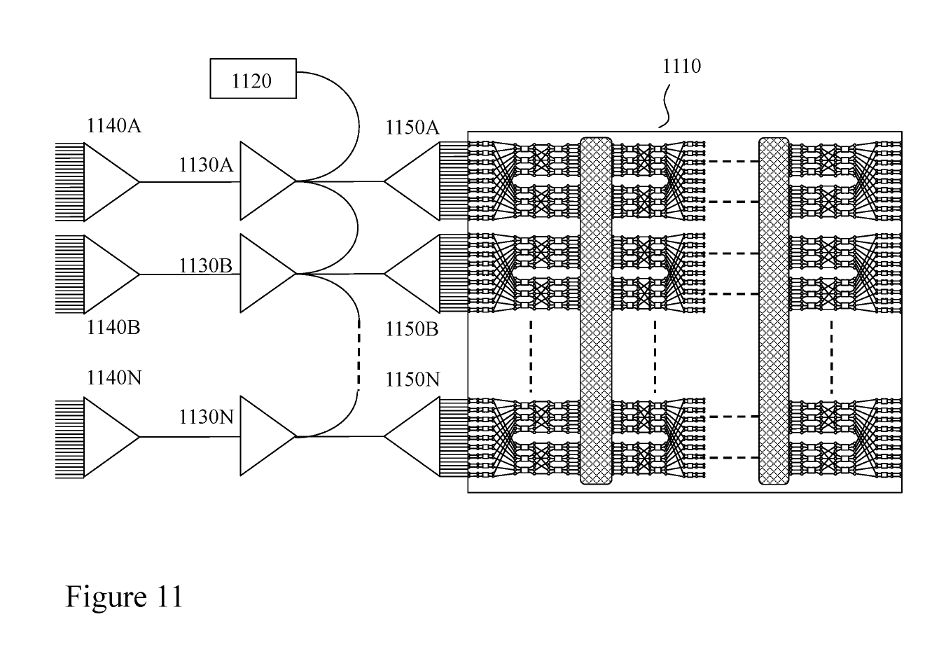

It would be apparent to one skilled in the art that for large mappers, e.g. 64×64, 128×128, 256×256, etc. that the optical loss across the mapper becomes significant having a theoretical value of IL=(3*N)+(4.8*M)dB where N is the number of 1×2 or 2×2 mapper elements, i.e. intrinsic loss of 3 dB, and M is the number of 1×3/2×3/3×3 mapper elements, i.e. intrinsic loss of 4.8 dB. Accordingly, a 9×9 mapper such as depicted in FIG. 2A has {N=0,M=2} and hence IL=9.6 dB whilst the 18×18 mapper depicted in FIG. 2B has {N=1,M=2} and hence IL=12.6 dB. Now referring to FIG. 11 there is depicted a mapper 1110 according to an embodiment of the invention which is coupled to a plurality of optical demultiplexers (DMUXs) 1150A to 1150N respectively. Each optical DMUX 1150A to 1150N is coupled to a plurality of optical multiplexers (MUXs) 1140A to 1140N respectively via an array of erbium doped optical fiber amplifiers (EDFAs) 1130A to 1130N.

In order to reduce the power consumption the inventors exploit their invention as disclosed within Liu et al entitled “Methods and Devices for Efficient Optical Fiber Amplifiers” published as US 2014/0,139,908. In this the plurality of EDFAs 1130A to 1130N are coupled (daisy-chained) together and coupled to a pump source module 1120 such that unused optical pump signal power from pump source 1120 by first EDFA 1130A is then coupled to second EDFA 1130B etc. In this manner the embodiments of the invention provide for large mappers. The EDFA array may be placed before or after the optical mapper. For very large optical mappers additional optical gain stages may be disposed within the optical mapper. Within other embodiments of the invention the optical mapper may employed arrayed semiconductor optical amplifiers, arrayed silica waveguide optical amplifiers, arrayed ion exchanged waveguide optical amplifiers, etc. according to the dimensions of the optical mapper, the loss distribution, overall loss budget, acceptable signal to noise ratio, noise figure, etc.

Within an alternate embodiment of the invention all or a subset of the optical demultiplexers (DMUXs) 1150A to 1150N respectively may be replaced with optical splitters. According to another embodiment of the invention all or a subset of the optical multiplexers (MUXs) 1140A to 1140N and optical demultiplexers (DMUXs) 1150A to 1150N respectively may be implemented with other optical elements including, but not limited to, passive combiners and splitters, band wavelength MUXs and DMUXs, and interleavers/deinterleavers operating within a single band (e.g. C-band or L-band), multiple bands (e.g. C+S bands, C+L bands), or multiple windows such as 1310 nm and 1550 nm. It would also be evident that the optical multiplexers (MUXs) 1140A to 1140N and optical demultiplexers (DMUXs) 1150A to 1150N respectively may not map directly to each other as a result of additional optical combiners and/or splitters etc. For example, a 2×N optical splitter may be employed in place of an optical DMUX and be coupled to 2 M×1 optical combiners.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. An optical network comprising:
at least one optical mapper of a plurality of optical mappers; and
at least one electronic shuffler and reducer circuit of a plurality of electronic shuffler and reducer circuits, each electronic shuffler and reducer circuit coupled to an output port of an optical mapper of the plurality of optical mappers.

2. The optical network according to claim 1, further comprising an optical amplifier array for amplifying either the input signals to a predetermined subset of the optical mappers and the output signals of a predetermined subset of the optical mappers, wherein each optical amplifier within the optical amplifier array is coupled to at least one other optical amplifier in order to provide for optical pump reuse.

3. (canceled)

4. (canceled)

5. A device comprising:
an wavelength demultiplexer for receiving a wavelength division multiplexed optical signal and demultiplexing it to a plurality of optical outputs, each optical output associated with a predetermined wavelength range;
a multiplexer for generating a multiplexed signal by multiplexing a plurality of electrical signals;
a plurality of channel processors, each channel processor coupled to an optical output of the plurality of optical outputs and comprising;
an optoelectronic converter; and
a serial to parallel converter coupled to the optoelectronic converter and generating parallel data in dependence upon serial data received by the serial to parallel converter from the optoelectronic converter;
a shuffle circuit comprising a plurality of input channels and a plurality of output channels, each input channel coupled to a predetermined channel processor of the plurality of channel processors and each output channel coupled to the a predetermined input port on the multiplexer to provide an electrical signal of the plurality of electrical signals.

6. The device according to claim 5, further comprising;
a plurality of buffer circuits, each buffer circuit of the plurality of buffer circuits disposed between a predetermined channel processor and the associated input channel of the shuffle circuit; and
a memory module, the memory module coupled all outputs of the plurality of buffer circuits.

7. A device comprising:
a fully connected optical distribution network comprising N input channels for receiving N optical signals comprising optical signals according to a predetermined optical channel plan and M output channels wherein each output channel comprises all optical signals received at the N input channels; and
M mapper—reducer circuits, each mapper—reducer circuit coupled to an output channel of the fully connected optical distribution network.

8. The device according to claim 7, wherein each mapper—reducer circuit comprises
an wavelength demultiplexer for receiving a wavelength division multiplexed optical signal and demultiplexing it to a plurality of optical outputs, each optical output associated with a predetermined wavelength range;
a multiplexer for generating a multiplexed signal by multiplexing a plurality of electrical signals;
a plurality of channel processors, each channel processor coupled to an optical output of the plurality of optical outputs and comprising;
an optoelectronic converter; and
a serial to parallel converter coupled to the optoelectronic converter and generating parallel data in dependence upon serial data received by the serial to parallel converter from the optoelectronic converter;
a shuffle circuit comprising a plurality of input channels and a plurality of output channels, each input channel coupled to a predetermined channel processor of the plurality of channel processors and each output channel coupled to a predetermined input port on the multiplexer to provide an electrical signal of the plurality of electrical signals.

9. The device according to claim 8, further comprising;
a plurality of buffer circuits, each buffer circuit of the plurality of buffer circuits disposed between a predetermined channel processor and the associated input channel of the shuffle circuit; and
a memory module, the memory module coupled all outputs of the plurality of buffer circuits.

10. The device according to claim 7, further comprising;
R optical amplifiers, each optical amplifier disposed on a predetermined input channel of the N input channels, wherein the R optical amplifiers are coupled sequentially to a single optical pump source such that apart from the first optical amplifier of the R optical amplifiers each optical amplifier receives the unused pump power from its preceding optical amplifier.

11. The optical network according to claim 1, further comprising
a plurality of data sources coupled to the inputs of the plurality of optical mappers; and
a plurality of data receivers each coupled to an output of an electronic shuffler and reducer circuit of the plurality of electronic shuffler and reducer circuits; wherein
the optical network supports:
broadcasting from a single data source to all data receivers;
multicasting from a subset of data sources of the plurality of data sources to a subset of data receivers of the plurality of data receivers, wherein each data source of the subset of data sources of the plurality of data sources is coupled to all data receivers within the subset of data receivers of the plurality of data receivers;
incasting from all data source to a single data receiver; and
point-to-point wherein a predetermined data source of the plurality of data sources is coupled to a predetermined data receiver of the plurality of data receivers.

12. The optical network according to claim 1, further comprising
a plurality of data sources coupled to the inputs of the plurality of optical mappers; and
a plurality of N data receivers each coupled to an output of an electronic shuffler and reducer circuit of the plurality of electronic shuffler and reducer circuits; wherein
each data source transmits an N -bit routing packet wherein each bit within the N -bit routing packet is associated with a predetermined data receiver of the N data receivers such that whether a data receiver receives and processes data transmitted by a data source is determined by the appropriate bit within the N -bit routing packet from the data source.
